(19) United States
(12) Patent Application Publication
(10) Pub. No.: US 2023/0394922 A1
(43) Pub. Date: Dec. 7, 2023

(54) INTELLIGENT NEAR MISS ELIMINATOR

(71) Applicant: IGT, Las Vegas, NV (US)

(72) Inventors: Soheil Latifi, Moncton (CA); Michael Russ, Graz (AT)

(21) Appl. No.: 17/834,082

(22) Filed: Jun. 7, 2022

(51) Int. Cl. G07F 17/32; G07F 17/34

(52) U.S. Cl. CPC G07F 17/326; G07F 17/34

(57) ABSTRACT

Embodiments are directed to enforcing responsible gaming, especially on the occurrence of near misses, by selectively modifying an appearance of an outcome of an electronic game to avoid triggering possible problem behaviors. Near misses, such as when two reels of a three-reel slots game have winning symbols stopping on a pay line but the third reel has a winning symbol stopping adjacent to or near the pay line, can trigger players and cause a change in their behavior. Embodiments of the present disclosure are directed to detecting problem gamblers at playtime and assessing a risk factor on each random miss before it is visualized to the player. If the near miss is assessed to be potentially triggering, it can be disguised as a total miss.

### BACKGROUND

The present disclosure is generally directed to responsible gaming and, in particular, toward methods and systems for selectively modifying an appearance of an outcome of an electronic game to avoid triggering possible problem behaviors.

In casino and similar games, a near miss is when game elements partially align or otherwise indicate a winning combination or situation by not all required for an actual win. For example, a near miss in a game of slots can occur when two reels of a three-reel game have winning symbols stopping on a pay line but the third reel has a winning symbol stopping adjacent to or near the pay line. The near miss concept is important to the gambling industry, especially in Electronic Gaming Machines (EGMs), since they can build excitement and encourage players to continue playing which leads to increased revenues. However, they can also trigger some players to engage in irresponsible or problematic behavior. So from a responsible gaming point of view, near misses are considered negative components, game designers, mathematicians, and others rely on them for creating more exciting and profitable games. Currently, responsible gaming enforcement systems issue warnings abruptly when problem gambling behaviors are detected. However, such warnings can offend players and halt their playing session. Hence, there is a need in the art for improved methods and system to enforce responsible gaming, especially on the occurrence of near misses.

### BRIEF SUMMARY

In certain embodiments, the present disclosure relates to systems and methods for selectively modifying an appearance of an outcome of an electronic game to avoid triggering possible problem behaviors. According to one embodiment, a responsible gaming system can comprise a communications interface coupled with a communications network, a processor coupled with the communications interface, and a memory coupled with and readable by the processor. The memory can store therein a set of instructions which, when executed by the processor, causes the processor to receive, from an gaming system, via the communication interface, game status information for a first electronic wager made by a player on an electronic game with a player on the gaming system detect a result of the first electronic wager based on the received game status information for the first electronic wager and identify a type of player behavior for the player in the first electronic wager. For example, identifying the type of player behavior for the player can be based on a predefined electronic player profile for the player. Additionally, or alternatively, identifying the type of player behavior for the player can be based on the received game status information and a predefined model of player behaviors. In such cases, the instructions can further cause the processor to apply machine learning to the predefined model of player behaviors based on the received game status information for the first electronic wager and the received game status information for the second electronic wager.

The instructions can further cause the processor to determine, based on the identified type of player behavior for the player in the first electronic wager and the detected result of the first electronic wager whether to intervene in a second electronic wager made by the player on the electronic game. For example, the type of player behavior may indicate problem gambling behavior. Determining whether to intervene in the second electronic wager can comprise determining a probability that the result of the second electronic gaming will cause the player to engage in the problem gambling behavior and determining whether the probability that the result of the second electronic wager will cause the player to engage in the problem gambling behavior exceeds a predefined threshold.

In response to determining to intervene in the second electronic wager, the instructions can further cause the processor to receive, from the gaming system, via the communication interface, game status information for the second electronic wager, detect a result of the second electronic wager based on the received game status information for the second electronic wager, and in response to the result of the second wager having one of a plurality of predefined possible result appearances, instructing, through the communications interface, the gaming system to modify an appearance of the result of the second electronic wager. In response to determining to not intervene in the second electronic wager, the instructions can further cause the processor to receive, from the gaming system, via the communication interface, game status information for the second electronic wager being conducted with the player on the gaming system, identify a type of player behavior for the player in the second electronic wager, detect a result of the second electronic wager based on the received game status information for the second electronic wager, and determine, based on the identified type of player behavior for the player in the second electronic wager and the detected result of the second electronic wager whether to intervene in a third electronic wager conducted with the player on the gaming system.

According to another embodiment, a method for operating an electronic game can comprise receiving, by a responsible gaming system, from a gaming system, game status information for a first electronic wager made by a player on an electronic game with a player on the gaming system, detecting, by the responsible gaming system, a result of the first electronic wager based on the received game status information for the first electronic wager, and identifying, by the responsible gaming system, a type of player behavior for the player in the first electronic wager. For example, an electronic profile for the player can be maintained by the responsible gaming system and identifying the type of player behavior for the player can be based on the maintained electronic player profile for the player. Additionally, or alternatively, a model defining player behaviors can be maintained by the responsible gaming system and identifying the type of player behavior for the player can be based on the maintained model of player behaviors. In such cases, machine learning can be applied, by the responsible gaming system, to the predefined model of player behaviors based on the received game status information for the first electronic wager and the received game status information for the second electronic wager.

A determination can be made, by the responsible gaming system, based on the identified type of player behavior for the player in the first electronic wager and the detected result of the first electronic wager whether to intervene in a second electronic wager made by the player on the electronic game. In response to determining to intervene in the second electronic wager, the responsible gaming system can instruct the gaming system to modify an appearance of the result of the second electronic wager without changing an actual result of the second electronic wager.

The actual result comprises a winning result or a non-winning result and can be represented on the gaming system by a plurality of symbols with one symbol of the plurality of symbols at each of a plurality of pre-defined locations on an interface of the gaming system. A winning result can be represented by a predefined one of the plurality of symbols being presented at each of the plurality of pre-defined locations on the interface of the gaming system. A non-winning result can be represented by the predefined one of the plurality of symbols being presented at less than all of the plurality of pre-defined locations on the interface of the gaming system. Instructing the gaming system to modify an appearance of the result of the second electronic wager can comprise instructing the gaming system to prevent the predefined one of the plurality of symbols from being presented adjacent to any of the plurality of pre-defined locations on the interface of the gaming system when the actual result is a non-winning result.

According to yet another embodiment, a gaming system can comprise a communications interface communicatively coupled with a communications network, an output device, a processor coupled with the communications interface and the output device, and a memory coupled with and readable by the processor. The memory can store therein a set of instructions which, when executed by the processor, causes the processor to initiate an electronic game with a player, provide game status information for the electronic game to a responsible gaming system via the communications interface while the electronic game is being conducted, receive, from the responsible gaming system, via the communications interface, an electronic message instructing the gaming system to modify an appearance of a result of the electronic game without modifying an actual result of the electronic game, and determine the actual result of the electronic game. The actual result comprises a winning result or a non-winning result,

In response to determining the actual result of the electronic game is a winning result, the instructions can cause the processor to present an appearance of the winning result on the output device. In response to determining the actual result of the electronic game is a non-winning result and based on receiving the electronic message, the instructions can cause the processor to modify an appearance of the non-winning result on the output device.

In some cases, the actual result can be represented on the output device by a plurality of symbols with one symbol of the plurality of symbols at each of a plurality of pre-defined locations and a winning result can be represented by a predefined one of the plurality of symbols being presented at each of the plurality of pre-defined locations. For example, the electronic game can comprise an electronic slots game. A non-winning result can be represented by the predefined one of the plurality of symbols being presented at less than all of the plurality of pre-defined locations. In such cases, modifying the appearance of the non-winning result comprises preventing the predefined one of the plurality of symbols from being presented adjacent to any of the plurality of pre-defined locations.

Additional features and advantages are described herein and will be apparent from the following Description and the figures.

### BRIEF DESCRIPTION OF THE SEVERAL VIEWS OF THE DRAWINGS

FIG. 1 is a block diagram illustrating an exemplary environment in which embodiments of the present disclosure may be implemented.

FIG. 2 is a diagram illustrating elements of an exemplary game upon which embodiments described herein can be applied.

FIG. 3 is a block diagram illustrating additional details of an exemplary gaming system in which responsible gaming can be applied according to embodiments of the present disclosure.

FIG. 4 is a block diagram illustrating additional details of an exemplary responsible gaming system for applying responsible gaming functions according to embodiments of the present disclosure.

FIG. 5 is a flowchart illustrating an exemplary process for applying responsible gaming according to one embodiment of the present disclosure.

FIG. 6 is a flowchart illustrating an exemplary process for executing an electronic game based on responsible gaming functions according to one embodiment of the present disclosure.

### DETAILED DESCRIPTION

Embodiments of the present disclosure will be described in connection with methods and systems for enforcing responsible gaming, especially on the occurrence of near misses, by selectively modifying an appearance of an outcome of an electronic game to avoid triggering possible problem behaviors. Near misses, such as when two reels of a three-reel slots game have winning symbols stopping on a pay line but the third reel has a winning symbol stopping adjacent to or near the pay line, can trigger players and cause a change in their behavior. Players usually react to these events and apparently enjoy this concept. This increases player involvement as well as revenues for the casino or game operator. On the other hand, problem gamblers may react to near misses intensely. For example, they may speed up playing, they may place more bets, and/or otherwise get heavily involved with the game. Embodiments of the present disclosure are directed to detecting problem gamblers at playtime and assessing a risk factor on each random miss before it is visualized to the player. If the near miss is assessed to be potentially triggering, it can be disguised as a total miss. This is believed to be less disturbing to the players as it is done subtly not directly issuing warnings to the players. According to embodiments of the present disclosure, the actual result of the game, i.e., a win or not a win, is not changed but rather, the appearance of the result, i.e., presenting a near miss, is changed. In this way, the game's volatility or chances will not change and if the distribution of wins and losses are monitored over time it will not be financially for the casino or operator of the game since there is no impact on the financial outcome given by a near miss.

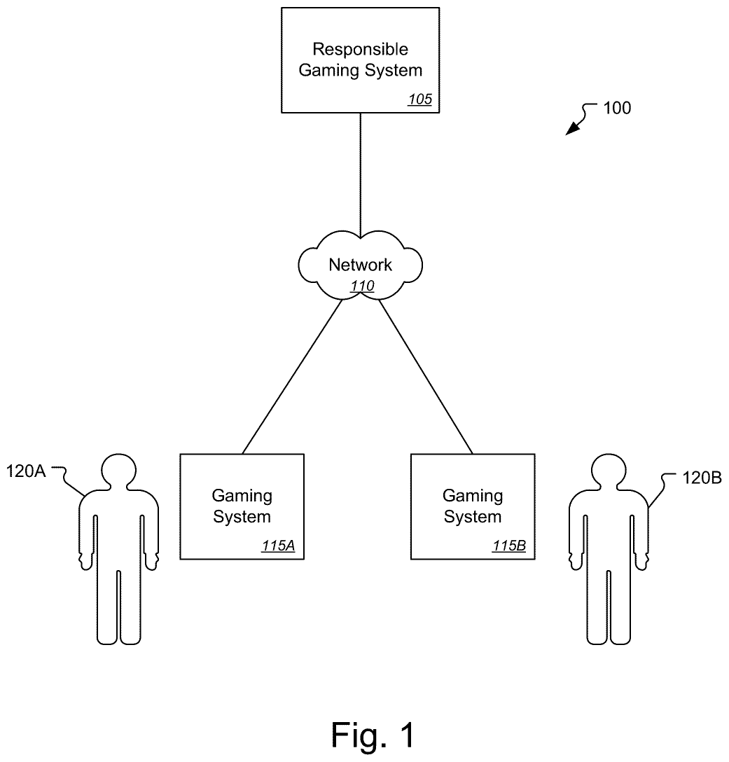

FIG. 1 is a block diagram illustrating an exemplary environment in which embodiments of the present disclosure may be implemented. As illustrated in this example, the environment 100 can comprise a responsible gaming system 105 which may be implemented on any one or more servers or other computing devices. The responsible gaming system 105 can be coupled with one or more wired and/or wireless communications networks 110, including and local and/or wide area networks such as a local Ethernet network within a casino or other gaming venue, the Internet, and/or others.

The environment 100 can also include any number of gaming systems 115A and 115B also coupled with the network 110. The gaming systems 115A-115B can comprise any of a variety of systems including, but not limited to an Electronic Gaming Machine (EGM), a personal computer executing a game application, a mobile device such as a tablet or smart phone executing a game app, etc. The gaming systems 115A and 115B may be installed in the same physical location or facility, such as a casino or other gaming venue, or may be widely distributed in a variety of physical locations. Each of the gaming systems can provide an electronic game to a player 120A and 120B.

According to one embodiment, the responsible gaming system 105 can monitor game play activity by the players 120A and 120B on each of the gaming systems 115A and 115B for indications of problem gambling. As known in the art, the responsible gaming system 10 can utilize a variety of methods for detecting problem gambling. For example, the responsible gaming system 105 may maintain player profiles for various players. These profiles may be generated and/or modified by the players themselves. In some cases, the play may set an indication that they feel they might have a gambling problem or may otherwise wish to have some limitations imposed on their game play activities. In other cases, the profiles may be defined and/or modified by other people such as casino staff, for example. In yet another example, and as known in the art, the responsible gaming system 105 may maintained learned models of player behavior that include indications of possible gambling problems. By monitoring player behavior and comparing it to these models, the responsible gaming system 105 can decide to take some responsible gaming action related a player.

According to one embodiment and as introduced above, the responsible gaming action can comprise selectively limiting some appearance of game results to prevent the player from being triggered into irresponsible or problematic behavior. More specifically, the responsible gaming system 105, upon detecting possible problem gambling behavior of a player 120A by monitoring game status information from the gaming system 115A can instruct the gaming system 115A to present non-winning results in a manner, i.e., to avoid presenting near misses, to avoid triggering the player 115A into further irresponsible behavior.

When the gaming system 115A receives such an instruction from the responsible gaming system 105, it does not change the determination of the actual result of the game which is determined mathematically according to methods known in the art. If the actual result is a win, that result can be presented normally. If the result is not a win and no near misses are indicated, that result can be presented by the gaming system 115A as it normally would be. However, if the result is a near miss, e.g., two reels of a three-reel slot game stop with winning symbols on the pay line but the third is not, the gaming system can avoid presenting a result with a winning symbol on the third reel adjacent to or nearby the pay line to avoid triggering the player 120A.

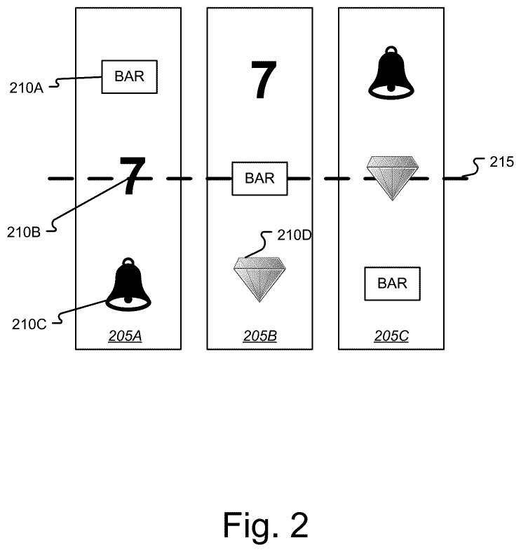

FIG. 2 is a diagram illustrating elements of an exemplary game upon which embodiments described herein can be applied. More specifically, this example illustrates reels 205A-205C of a three-reel slots game as may be played on a gaming system 115 such as an Electronic Gaming Machine (EGM) or other device including, but not limited to, a computer or mobile device executing a game application. The reels 205A-205C can be mechanical reels or a graphical representation of mechanical reels presented on a display. It should be noted that while this example illustrates a three-reel slots game, embodiments are equally applicable to five-reel or other slots game. Similarly, it should be noted that while his example illustrates and describes a slots game, embodiments are equally applicable to other types of games in which results are presented and based on a position of one or more game symbols or pieces and in which near misses may occur. One example of such a game can be roulette. Other games are similarly contemplated and are considered to be within the scope of the present disclosure.

As generally known, symbols 210A-210D are presented on the reels 205A-205C and spun or given the appearance of spinning. One of the symbols 210A can be considered a winning symbol while the others 210B-210D may not be. If the winning symbol 210A stops at a particular position, i.e., the pay line 215 when the reel stops spinning it represents a possible win, such as shown on reel 205B in this example. If the winning symbol stops at the pay line 215 on each reel 205A-205C, the spin is considered a win and a payout is made. However, if less than all reels 205A-205C show the winning symbol 210A at the pay line 215, the result is not a win. If, as shown in this example, a winning symbol 210A stops at the pay line 215 of one of the reels 205B or even a second reel (not shown in this example), but stops adjacent to or near by that position as shown on reels 205A and 205C in this example, the result is considered to be a near miss. As descried herein, embodiments are directed to selectively preventing this situation when problem gambling behavior is detected. To prevent this situation, when a non-winning spin is made, the end result is presented so that a symbol other than the winning symbol 210A is presented at location adjacent to the pay line. It should be noted that this is not a change of the actual result, i.e., a win or not a win, which is determined mathematically before the reels are stops as known in the art. Rather, embodiments described herein change only the appearance of the result to avoid presenting a near miss in some cases.

Stated another way, the actual result comprises a winning result or a non-winning result and can be represented on the gaming system by a plurality of symbols 210A-210D with one symbol 210A of the plurality of symbols at each of a plurality of pre-defined locations, i.e., along the pay line 215 on an interface, i.e., the reels 205A-205C of the gaming system. A winning result can be represented by a predefined symbol 210A of the plurality of symbols 210A-210D being presented at each of the plurality of pre-defined locations on the interface of the gaming system. A non-winning result can be represented by the predefined symbol 210A of the plurality of symbols 210A-210D being presented at less than all of the plurality of pre-defined locations along the pay line 215 on the interface of the gaming system 115. Modifying an appearance of the result can be done by the gaming system 115 preventing the predefined symbol 210A from being presented adjacent to any of the plurality of pre-defined locations along the pay line 215 on the interface of the gaming system when the actual result is a non-winning result.

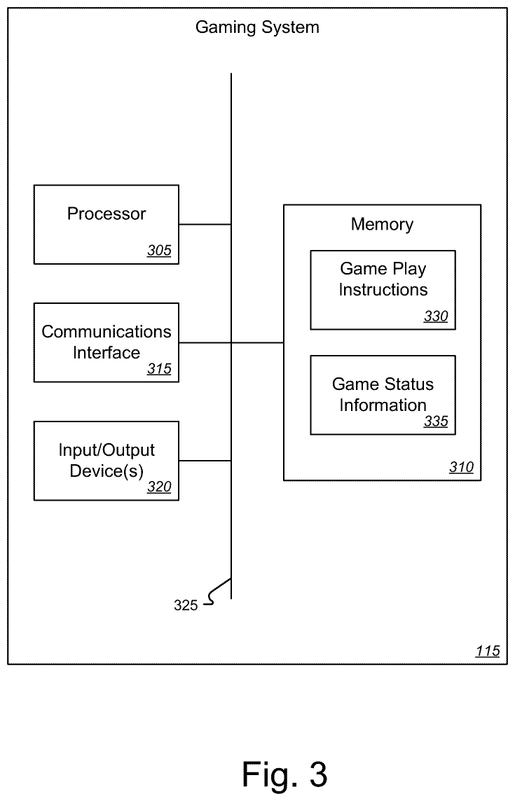

FIG. 3 is a block diagram illustrating additional details of an exemplary gaming system in which responsible gaming can be applied according to embodiments of the present disclosure. As illustrated in this example, the gaming system 115 can comprise a processor 305. The processor 305 may correspond to one or many computer processing devices. For instance, the processor 305 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 305 may be provided as a microprocessor, Central Processing Unit (CPU), or plurality of microprocessors that are configured to execute the instructions sets stored in a memory 310. Upon executing the instruction sets stored in memory 310, the processor 305 enables various functions of the gaming system 115 as described herein.

The memory 310 can be coupled with and readable by the processor 305 via a communications bus 325. The memory 310 may include any type of computer memory device or collection of computer memory devices. Non-limiting examples of memory 310 include Random Access Memory (RAM), Read Only Memory (ROM), flash memory, Electronically-Erasable Programmable ROM (EEPROM), Dynamic RAM (DRAM), etc. The memory 310 may be configured to store the instruction sets depicted in addition to temporarily storing data for the processor 305 to execute various types of routines or functions.

The processor 305 can also be coupled with one or more communications interfaces 315 and one or more input/output devices 320 via the bus 325. The communication interfaces 315 can comprise, for example, Ethernet, Bluetooth, WiFi, or other type of wired or wireless communications interfaces. The input/output devices 320 can comprise, for example, a display such as a Liquid Crystal Display (LCD), Light Emitting Diode (LED), Organic Light Emitting Diode (OLED), display or other type of display for presenting images and other graphics and can be touch sensitive allowing the user to use the display 320 as an input device as well. Additionally, or alternatively, the input/output devices 320 can comprise any combination of reels, buttons, lights, and/or other input/output devices.

The memory 310 can store therein a set of game play instructions 330 which, when executed by the processor 305, causes the processor 305 to initiate an electronic game with a player 120, provide game status information 335 for the electronic game to a responsible gaming system 105 via the communications interface 315 while the electronic game is being conducted, receive, from the responsible gaming system 105, via the communications interface 315, an electronic message instructing the gaming system 115 to modify an appearance of a result of the electronic game without modifying an actual result of the electronic game, and determine the actual result of the electronic game. The actual result can comprise a winning result or a non-winning result.

In response to determining the actual result of the electronic game is a winning result, the game play instructions 330 can cause the processor 305 to present an appearance of the winning result on the output device 320. In response to determining the actual result of the electronic game is a non-winning result and based on receiving the electronic message, the game play instructions 330 can cause the processor 305 to modify an appearance of the non-winning result presented on the output device 30.

In some cases, the actual result can be represented on the output device 320 by a plurality of symbols with one symbol of the plurality of symbols at each of a plurality of pre-defined locations and a winning result can be represented by a predefined one of the plurality of symbols being presented at each of the plurality of pre-defined locations. For example, the electronic game can comprise an electronic slots game. A non-winning result can be represented by the predefined one of the plurality of symbols being presented at less than all of the plurality of pre-defined locations. In such cases, modifying the appearance of the non-winning result can comprise preventing the predefined one of the plurality of symbols, i.e., a winning symbol, from being presented adjacent to or within a predefined number of locations of any of the plurality of pre-defined locations, i.e., a near miss can be concealed or not presented.

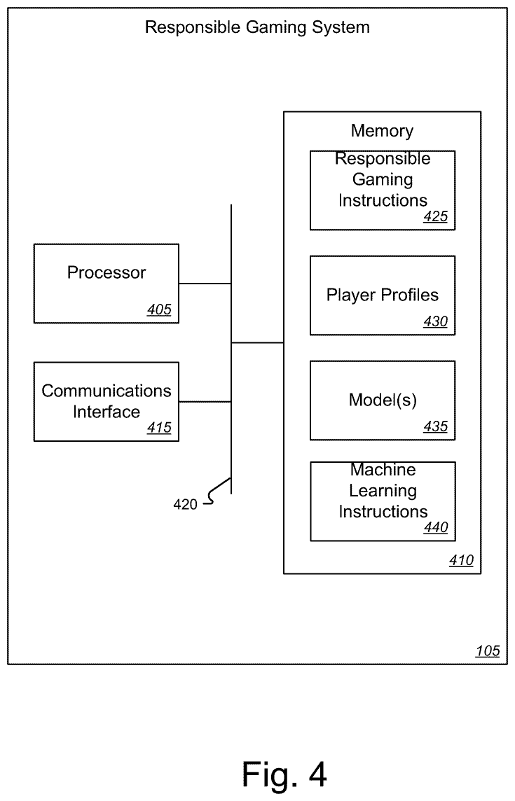

FIG. 4 is a block diagram illustrating additional details of an exemplary responsible gaming system for applying responsible gaming functions according to embodiments of the present disclosure. As illustrated in this example, the responsible gaming system 105 can comprise a processor 405 such as any of the various types of processors described above. A memory 410 can be coupled with and readable by the processor 405 via a communications bus 420. The memory 410 can comprises any one or more of the different types of volatile and/or non-volatile memories described above. The processor 405 can also be coupled with one or more communication interfaces 415 via the communications bus 420. The communication interfaces 415 can comprise, for example, Ethernet, Bluetooth, WiFi, or other type of wired or wireless communications interfaces.

The memory 410 can store therein a set of responsible gaming instructions 425 which, when executed by the processor 405, causes the processor 405 to receive, from an gaming system 115, via the communication interface 415, game status information 335 for a first electronic wager made by a player on an electronic game with a player 120 on the gaming system 115, detect a result of the first electronic wager based on the received game status information for the first electronic wager, and identify a type of player behavior for the player 120 in the first electronic wager. For example, identifying the type of player behavior for the player can be based on a predefined electronic player profile 430 for the player. Additionally, or alternatively, identifying the type of player behavior for the player can based on the received game status information and a predefined responsible gaming model 435 of player behaviors. In such cases, a set of machine learning instructions 440 stored in the memory 410 can further cause the processor 405 to apply machine learning to the predefined model 435 of player behaviors based on the received game status information.

The responsible gaming instructions 425 can further cause the processor 405 to determine, based on the identified type of player behavior for the player in the first electronic wager and the detected result of the first electronic wager whether to intervene in a second electronic wager made by the player on the electronic game. For example, the type of player behavior may indicate problem gambling behavior. Determining whether to intervene in the second electronic wager can comprise determining a probability that the result of the second electronic gaming will cause the player to engage in the problem gambling behavior and determining whether the probability that the result of the second electronic gaming will cause the player to engage in the problem gambling behavior exceeds a predefined threshold.

In response to determining to intervene in the second electronic wager, the responsible gaming instructions 425 can further cause the processor 405 to receive, from the gaming system 115, via the communication interface 415, game status information for the second electronic wager, detect a result of the second electronic wager based on the received game status information for the second electronic wager, and in response to the result of the second wager having one of a plurality of predefined possible result appearances, instruct, through the communications interface 415, the gaming system 115 to modify an appearance of the result of the second electronic wager, i.e., conceal or not present a near miss. In response to determining to not intervene in the second electronic wager, the responsible gaming instructions 425 can further cause the processor 405 to continue to monitor game play at the gaming system 115, i.e., receive, from the gaming system 115, via the communication interface 415, game status information for the second electronic wager being conducted with the player 120 on the gaming system 115, identify a type of player behavior for the player in the second electronic wager, detect a result of the second electronic wager based on the received game status information for the second electronic wager, and determine, based on the identified type of player behavior for the player in the second electronic wager and the detected result of the second electronic wager whether to intervene in a third electronic wager conducted with the player on the gaming system.

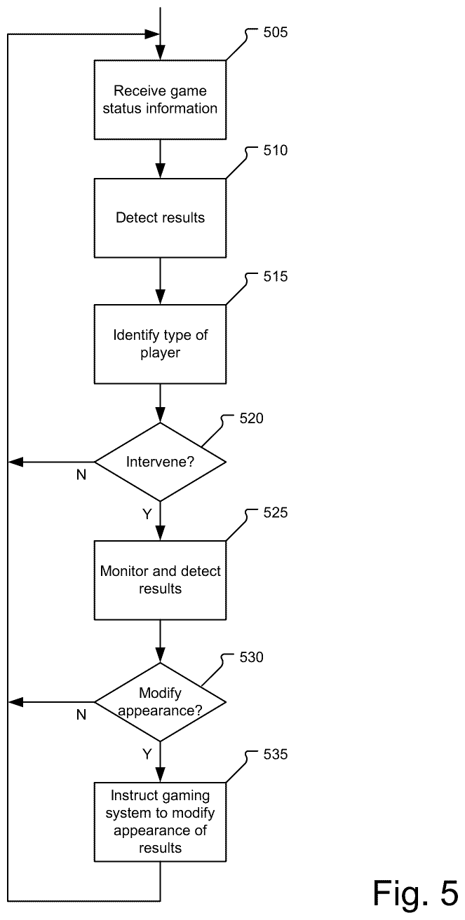

FIG. 5 is a flowchart illustrating an exemplary process for applying responsible gaming according to one embodiment of the present disclosure. More specifically, this example illustrates a process as may be performed by a responsible gaming system 105 as described above. As illustrated in this example, the process may begin with receiving 505, from a gaming system 115, game status information 335 for a first electronic wager made by a player on an electronic game with a player 120 on the gaming system 115, detecting 510 a result of the first electronic wager based on the received game status information 335 for the first electronic wager, and identifying 515 a type of player behavior for the player 120 in the first electronic wager. For example, an electronic profile 430 for the player 120 can be maintained and identifying 510 the type of player behavior for the player 120 can be based on the maintained electronic player profile 430 for the player 120, e.g., based on a player identifier, account number, or other information received in or with the game status information 335. In such an example, the player profile 430 can store an indication that can be set by the player, casino personnel or another person, or by automated responsible gaming functions based on past player activity and indicating that the player 120 should be monitored for potential problem gambling behavior. Additionally, or alternatively, a learned model 435 defining potentially problematic player behaviors can be maintained by the responsible gaming system 105 and identifying 510 the type of player behavior for the player 120 can be based on the maintained model 435 of player behaviors and activities of the player 120 detected from the received game status information 335.

A determination 520 can be made based on the identified type of player behavior for the player 120 in the first electronic wager and the detected 515 result of the first electronic wager whether to intervene in a second electronic wager conducted with the player 120 on the gaming system 115.

The actual result can comprise a winning result or a non-winning result and can be represented on the gaming system 115 by a plurality of symbols with one symbol of the plurality of symbols at each of a plurality of pre-defined locations on an interface of the gaming system. A winning result can be represented by a predefined one of the plurality of symbols being presented at each of the plurality of pre-defined locations on the interface of the gaming system 115. A non-winning result can be represented by the predefined one of the plurality of symbols being presented at less than all of the plurality of pre-defined locations on the interface of the gaming system 115.

Results of a third or subsequent wager can be monitored and detected 525 and a determination 530 can be made as to whether an appearance of those results should be modified. In response to determining 530 to modify the appearance, the gaming system 115 can be instructed 535 to modify the appearance of the result of the electronic wager to prevent the predefined one of the plurality of symbols from being presented adjacent to any of the plurality of pre-defined locations on the interface of the gaming system 115 when the actual result is a non-winning result, i.e., an instruction to not show a near miss appearance.

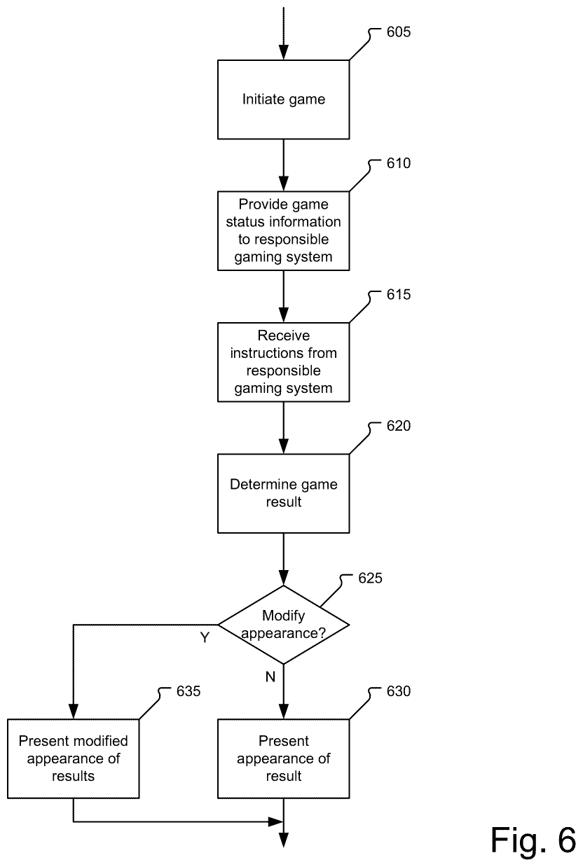

FIG. 6 is a flowchart illustrating an exemplary process for executing an electronic game based on responsible gaming functions according to one embodiment of the present disclosure. More specifically, this example illustrates a process as may be performed by a gaming system 115 as described above. As illustrated here, the process may begin with initiating 605 an electronic game with a player 120 and providing 610 game status information for the electronic game to a responsible gaming system 105 via the communications interface while the electronic game is being conducted. In response, an electronic message can be received 615 from the responsible gaming system 105 instructing that an appearance of a result of the electronic game should be modified without modifying an actual result of the electronic game.

The actual result of the electronic game can be determined 620 and a determination 625 can be made as to whether the appearance of the result should be changed. The actual result comprises a winning result or a non-winning result. In response to determining 625 the actual result of the electronic game is a winning result an unmodified appearance of the winning result can be presented 630. In response to determining 625 the actual result of the electronic game is a non-winning result and based on receiving 615 the electronic message, a modify appearance of the non-winning result can be presented 635.

As noted above, the actual result can be represented by a plurality of symbols with one symbol of the plurality of symbols at each of a plurality of pre-defined locations and a winning result can be represented by a predefined one of the plurality of symbols being presented at each of the plurality of pre-defined locations. For example, the electronic game can comprise an electronic slots game and a winning result can be presented as a winning symbol at the pay line for each reel. A non-winning result can be represented by the predefined one of the plurality of symbols being presented at less than all of the plurality of pre-defined locations. In such cases, modifying the appearance of the non-winning result can comprise preventing the predefined one of the plurality of symbols from being presented adjacent to any of the plurality of pre-defined locations, i.e., a near miss can be concealed or not presented.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Pat. No. 8,764,566, entitled “Internet Remote Game Server,” and U.S. Pat. No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A responsible gaming system comprising:
a communications interface coupled with a communications network;
a processor coupled with the communications interface; and
a memory coupled with and readable by the processor and storing therein a set of instructions which, when executed by the processor, causes the processor to:
receive, from a gaming system, via the communication interface, game status information for a first electronic wager made by a player on an electronic game being conducted with the player on the gaming system;
detect a result of the first electronic wager based on the received game status information for the first electronic wager;
identify a type of player behavior for the player in the electronic game;
determine, based on the identified type of player behavior for the player in the first electronic wager and the detected result of the first electronic wager whether to intervene in a second electronic wager made by the player on the electronic game; and
in response to determining to intervene in the second electronic wager, receive, from the gaming system, via the communication interface, game status information for the second electronic wager, detect a result of the second electronic wager based on the received game status information for the second electronic wager, and in response to the result of the second wager having one of a plurality of predefined possible result appearances, instructing, through the communications interface, the gaming system to modify an appearance of the result of the second electronic wager.

2. The responsible gaming system of claim 1, wherein identifying the type of player behavior for the player is based on a predefined electronic player profile for the player.

3. The responsible gaming system of claim 1, wherein identifying the type of player behavior for the player is based on the received game status information and a predefined model of player behaviors.

4. The responsible gaming system of claim 3, wherein the instructions further cause the processor to apply machine learning to the predefined model of player behaviors based on the received game status information for the first electronic wager and the received game status information for the second electronic wager.

5. The responsible gaming system of claim 1, wherein the type of player behavior indicates a problem gambling behavior.

6. The responsible gaming system of claim 5, wherein determining whether to intervene in the second electronic wager comprises determining a probability that the result of the second electronic gaming will cause the player to engage in the problem gambling behavior and determining whether the probability that the result of the second electronic gaming will cause the player to engage in the problem gambling behavior exceeds a predefined threshold.

7. The responsible gaming system of claim 1, wherein the instructions further cause the processor to, in response to determining to not intervene in the second electronic wager:
receive, from the gaming system, via the communication interface, game status information for the second electronic wager being conducted with the player on the gaming system;
identify a type of player behavior for the player in the second electronic wager;
detect a result of the second electronic wager based on the received game status information for the second electronic wager; and
determine, based on the identified type of player behavior for the player in the second electronic wager and the detected result of the second electronic wager whether to intervene in a third electronic wager conducted with the player on the gaming system.

8. A method for operating an electronic game, the method comprising:
receiving, by a responsible gaming system, from a gaming system, game status information for a first electronic wager made by a player on an electronic game with a player on the gaming system;
detecting, by the responsible gaming system, a result of the first electronic wager based on the received game status information for the first electronic wager;
identifying, by the responsible gaming system, a type of player behavior for the player in the first electronic wager;
determining, by the responsible gaming system, based on the identified type of player behavior for the player in the first electronic wager and the detected result of the first electronic wager whether to intervene in a second electronic wager made by the player on the electronic game; and
in response to determining to intervene in the second electronic wager, instructing, by the responsible gaming system, the gaming system to modify an appearance of the result of the second electronic wager without changing an actual result of the second electronic wager.

9. The method of claim 8, further comprising maintaining, by the responsible gaming system, an electronic profile for the player and wherein identifying the type of player behavior for the player is based on the maintained electronic player profile for the player.

10. The method of claim 8, further comprising maintaining, by the responsible gaming system, a model defining player behaviors and wherein identifying the type of player behavior for the player is based on the maintained model of player behaviors.

11. The method of claim 10, further comprising applying, by the responsible gaming system, machine learning to the predefined model of player behaviors based on the received game status information for the first electronic wager and the received game status information for the second electronic wager.

12. The method of claim 8, wherein the actual result comprises a winning result or a non-winning result.

13. The method of claim 12, wherein the actual result is represented on the gaming system by a plurality of symbols with one symbol of the plurality of symbols at each of a plurality of pre-defined locations on an interface of the gaming system and wherein a winning result is represented by a predefined one of the plurality of symbols being presented at each of the plurality of pre-defined locations on the interface of the gaming system.

14. The method of claim 13, wherein a non-winning result is represented by the predefined one of the plurality of symbols being presented at less than all of the plurality of pre-defined locations on the interface of the gaming system.

15. The method of claim 14, wherein instructing the gaming system to modify an appearance of the result of the second electronic wager comprises instructing the gaming system to prevent the predefined one of the plurality of symbols from being presented adjacent to any of the plurality of pre-defined locations on the interface of the gaming system when the actual result is a non-winning result.

16. A gaming system comprising:
a communications interface communicatively coupled with a communications network;
an output device;
a processor coupled with the communications interface and the output device; and
a memory coupled with and readable by the processor and storing therein a set of instructions which, when executed by the processor, causes the processor to:
initiate an electronic game with a player;
provide game status information for the electronic game to a responsible gaming system via the communications interface while the electronic game is being conducted;
receive, from the responsible gaming system, via the communications interface, an electronic message instructing the gaming system to modify an appearance of a result of the electronic game without modifying an actual result of the electronic game;
determine the actual result of the electronic game, wherein the actual result comprises a winning result or a non-winning result; and
in response to determining the actual result of the electronic game is a winning result, presenting an appearance of the winning result on the output device; and
in response to determining the actual result of the electronic game is a non-winning result and based on receiving the electronic message, modifying an appearance of the non-winning result on the output device.

17. The gaming system of claim 16, wherein the actual result is represented on the output device by a plurality of symbols with one symbol of the plurality of symbols at each of a plurality of pre-defined locations and wherein a winning result is represented by a predefined one of the plurality of symbols being presented at each of the plurality of pre-defined locations.

18. The gaming system of claim 17, wherein a non-winning result is represented by the predefined one of the plurality of symbols being presented at less than all of the plurality of pre-defined locations.

19. The gaming system of claim 18, wherein modifying the appearance of the non-winning result comprises preventing the predefined one of the plurality of symbols from being presented adjacent to any of the plurality of pre-defined locations.

20. The gaming system of claim 19, wherein the electronic game comprises an electronic slots game.
